(19) United States
(12) Patent Application Publication
(10) Pub. No.: US 2005/0133110 A1
(43) Pub. Date: Jun. 23, 2005

(54) Funnel stand

(76) Inventor: Leland Eugene Dossett, LaFollette, TN (US)

Correspondence Address: MICHAEL E. MCKEE;Attorney at Law, 804 Swaps Lane, Knoxville, TN, 37923, US

(21) Appl. No.: 10/847,527

(22) Filed: May 17, 2004

Related U.S. Application Data
(60) Provisional application No. 60/531,378, filed on Dec. 19, 2003.

(51) Int. Cl. B65B 1/04; B67C 3/00; B65B 3/04; B65B 31/00

(52) U.S. Cl. 141/18

(57) ABSTRACT

A funnel stand includes a base platform upon which an open-mouthed quart-sized container is positionable and a funnel portion having a discharge opening. Legs support the funnel portion in a spaced and elevated condition above the base platform, and the height of the spacing as measured between the discharge opening of the funnel portion and the base platform closely approximates the height of the quart-sized container so that when the quart-sized container is positioned upon the base platform, the mouth of the quart-sized container is positionable to accept fluid which flows out of the funnel portion through the discharge opening thereof.

The benefit of Provisional Application Ser. No. 60/531,378, filed Dec. 19, 2003 and entitled REFILLER FUNNEL STAND, is hereby claimed. The disclosure of this referenced provisional application is incorporated herein by reference.

### BACKGROUND OF THE INVENTION

This invention relates generally to means and methods for transferring fluid from one container to another container and relates, more particularly, to a funneling device facilitating the transfer of a fluid from one container to another container.

During the course of changing oil in an engine, used oil is commonly drained from the crankcase of the engine and collected, for example, in a shallow collection pan, and then the crankcase is refilled with new, unused oil which has been purchased in quart-sized containers. For ease of disposal of the used oil which has been collected within the collection pan, the used oil is commonly poured from the collection pan into the emptied quart-sized containers within which the new, unused oil was purchased, and then the used oil is returned to a recycling center, or station, within the quart-sized containers.

For purposes of transferring the used oil from the collection pan to the emptied quart-sized containers, a funnel can be placed within the mouth of a container so that the funnel is supported by the container, and then the used oil is poured from the collection pan into the funnel where it is directed downwardly into the container. However, such a quart-sized container is susceptible of tipping over as the oil is poured from the collection pan into the container-supported funnel; and if such a tipping over does occur, then used oil is likely to spill from the container or the funnel. It would therefore be desirable to provide a means for funneling used oil poured from a collection pan into an empty quart-sized container which reduces the likelihood that the quart-sized container will tip over as the used oil is poured from a collection pan into the quart-sized container.

Accordingly, it is an object of the present invention to provide a new and improved funnel stand facilitating the transfer of fluid from one container to another container.

Another object of the present invention to provide such a stand which is particularly well-suited for use when transferring a drained fluid, such as used motor oil, from a collection pan into a small (e.g. quart-sized) container for disposal.

Still another object of the present invention is to provide such a stand which is compact in size, uncomplicated in structure, and effective in operation.

### SUMMARY OF THE INVENTION

This invention resides in a funnel stand facilitating the funneling of fluid into a small container having an open mouth.

The stand includes a base platform having a support surface upon which a small, open-mouthed container is positionable so that the open mouth of the container is directed upwardly and a funnel portion having a relatively large entrance opening and a smaller discharge opening. The stand also includes means for supporting the funnel portion in an elevated condition above the base platform for funneling a fluid poured into the funnel portion downwardly through the discharge opening thereof and so that the height of the spacing as measured between the discharge opening of the funnel portion and the support surface of the base portion closely approximates the height of the small container. Therefore, when the container is positioned upon the support surface of the base platform so that the mouth of the container is positioned in vertical registry with the discharge opening of the funnel portion, the mouth of the container is closely positioned adjacent the discharge opening to accept fluid which flows out of the funnel portion through the discharge opening thereof.

### BRIEF DESCRIPTION OF THE DRAWINGS

FIG. 1 is a perspective view depicting the prior art process involving the funneling of used motor oil which has been collected within a collection pan into a quart-sized container.

FIG. 2 is a perspective view of an embodiment of a funnel stand within which features of the present invention are embodied.

FIG. 2a is a fragmentary perspective view of the funnel portion of the FIG. 2 stand, and drawn to a slightly larger scale.

FIG. 3 is a side elevational view of the FIG. 2 stand as seen generally from the left in FIG. 2.

FIG. 4 is a longitudinal cross-sectional view of the FIG. 2 stand as seen along line 4-4 of FIG. 3.

FIG. 5 is a top view of the FIG. 2 stand as seen generally from above in FIG. 2.

FIG. 6 is a perspective view illustrating the FIG. 2 stand and a quart-sized container positioned within the stand.

FIG. 7 is a fragmentary perspective view of another embodiment of a stand within which features of the present invention are embodied.

FIG. 8 is a top view of the FIG. 7 stand as seen generally from above in FIG. 7.

### DETAILED DESCRIPTION OF THE ILLUSTRATED EMBODIMENTS

Turning now to the drawings in greater detail, there is illustrated in FIG. 1 an exemplary prior art process of transferring used motor oil, indicated 12, which has been collected (e.g. drained from beneath a vehicle engine) within a shallow collection pan 14 into an empty, relatively small (e.g. quart-sized) container 16 by means of a funnel 18. For this purpose, the funnel 18 has been placed and thereby supported within the mouth of the container 16, and then the oil 12 is poured from the collection pan 14 and into the funnel 18 where the oil is directed downwardly into the container 16 for collection.

The container 16 within which the used oil is collected is envisioned to be a small container within which new, or replacement, motor oil is purchased for the purpose of replacing the used oil which has been drained from an engine and into the collection pan 14. In other words, once the used motor oil is drained from an engine and replaced with oil which was purchased in small (e.g. quart-sized) containers, then the empty containers are available for accepting used oil poured therein from the collection pan 14. As each container is filled with used oil, the container 16 is closed (e.g. with a screw-type top) and rendered ready to return to a recycling center for disposal. Since the number of quarts of used oil removed from an engine is rarely expected to exceed the number of quarts of oil replaced within the engine, there should always be enough empty small (e.g. quart-sized) containers on hand following an oil-changing operation to contain the used motor oil collected within the collection pan 14.

It will be appreciated, however, that as oil is poured into the funnel 18 from the collection pan 14 in the manner illustrated in FIG. 1, the container 16 is susceptible of tipping over. Such a susceptibility to tipping over is believed to be due to a number of factors, such as the relatively small size of the bottom of the container 16 and the disposition of the mouth of the container 16 to one size of the container—rather than being disposed centrally above the container bottom. The container 16 could be manually steadied by a second individual during the FIG. 1 oil-transferring process, but such a second individual is not always available when the oil-transferring process is desired to take place. As will be apparent, the invention described herein is intended to improve upon the illustrated prior art oil-transferring process of FIG. 1 in that it reduces the likelihood that a small container into which a fluid is funneled will tip over as the fluid is funneled therein.

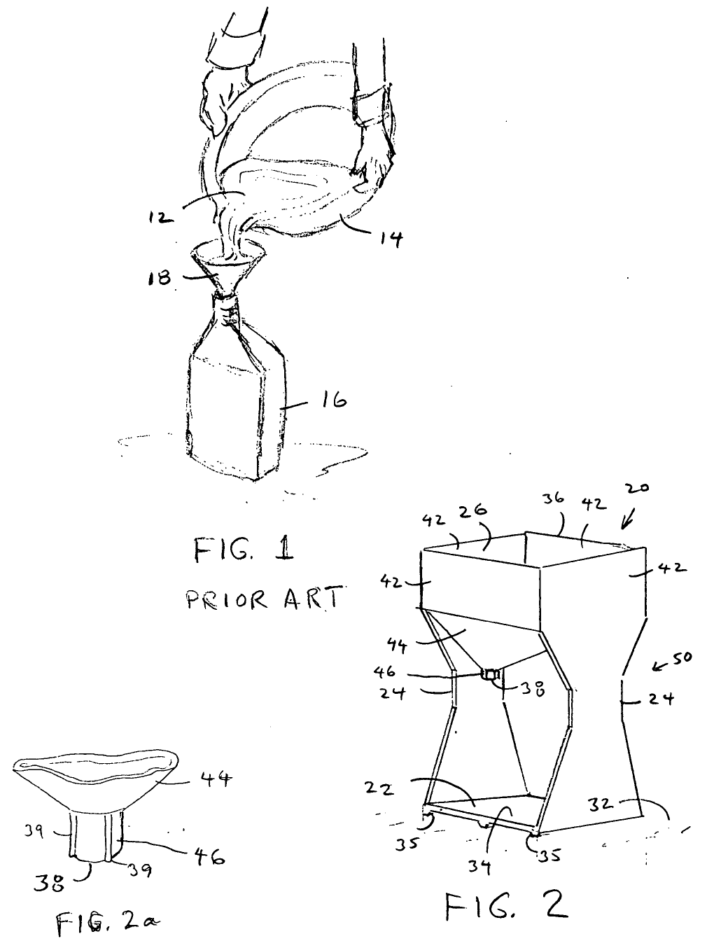

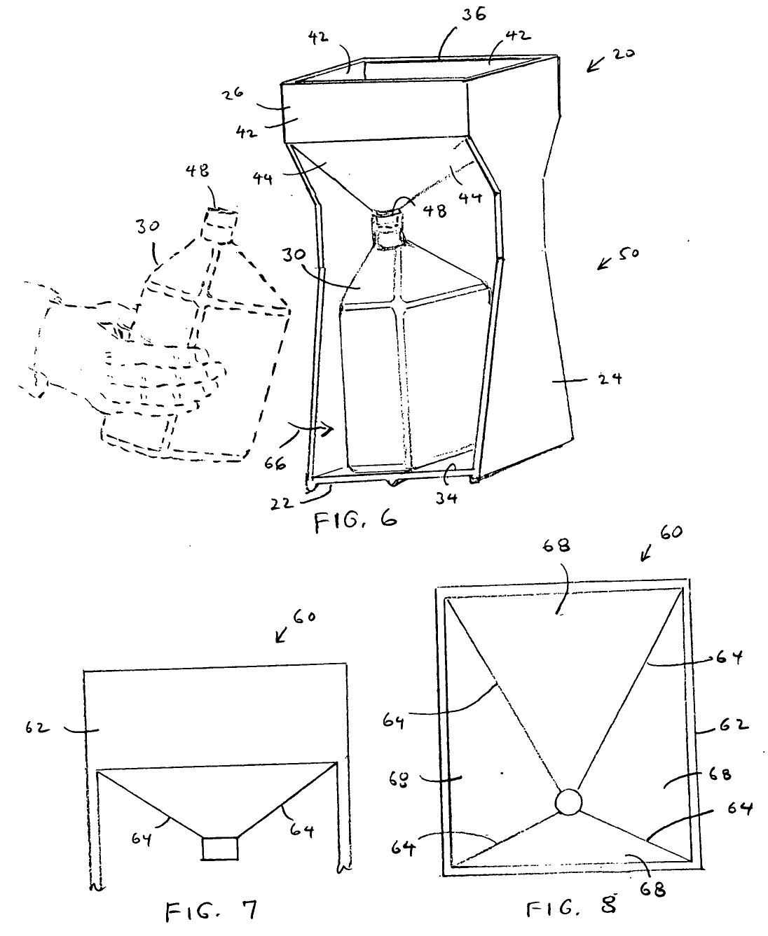

With reference to FIGS. 2-5, there is illustrated an embodiment, generally indicated 20, of a funnel stand within which features of the present invention are embodied. The depicted stand 20 includes a base platform 22, a pair of legs 24 extending upwardly from the base platform 22, and a funnel portion 26 supported in an elevation condition above the base platform 22 by the legs 24. As will be apparent herein, the legs 24 are spaced apart by a sufficient distance to permit an empty (e.g. quart-sized) container 30 (FIG. 6) to be positioned upon the base platform 22 and beneath the funnel portion 26 for acceptance of a fluid funneled into the container 30 by way of the funnel portion 26.

Although the embodiment 20 is described herein in conjunction with the transfer of an engine fluid (e.g. used motor oil) which has been drained from a vehicle engine into small, quart-sized containers (e.g. empty oil bottles), the embodiment 20 can be used to transfer other fluids from one container to another container. For example, a homemaker may employ the embodiment 20 described herein for transferring a quantity of cleaning fluid which has been purchased in a large, economy-sized container into a smaller (e.g. quart-sized) spray bottle from which the cleaning fluid is ultimately dispensed. Accordingly, the principles of the present invention can be variously applied.

With reference to FIGS. 2-5, the base platform 22 is platen-like in shape and is adapted to rest upon a floor 32 or similar underlying support surface. The platform 22 defines a flat, upwardly-facing, rectangular support surface 34 upon which a container 30 is positionable during use of the stand 20. If desired, the frictional grip between the support surface 34 and the bottom surface of the container 30 positioned thereon can be enhanced by providing the surface 34 with a roughened or soft, rubber-like texture. The base platform 22 can be constructed, for example, of hard plastic, but other materials can be used. If constructed (e.g. molded) out of plastic, strengthening ribs 35 can be integrally formed across the underside of the platform 22 for strengthening purposes.

The funnel portion 26 of the stand 20 has a relatively large, rectangular upper opening 36 and a smaller, circular discharge spout, or opening 38. The funnel portion 26 also has sidewalls 40 having straight-walled sections 42 which border the upper opening 36 and tapered sections 44 which are disposed beneath the straight-walled sections 42 and taper inwardly, or converge toward one another, as a path is traced downwardly from the straight-walled sections 42 toward the discharge opening 38. The discharge opening 38 is provided by a short, conduit section 46 which is joined to, so as to depend downwardly from, the lower end of the tapered section 44. Preferably, a plurality of vertically-disposed ribs 39 (best shown in FIG. 2a) are defined along (and thereby protrude from) the outer surface of the conduit section 46 for a reason which will be apparent herein. In the depicted stand 20, there are four such ribs 39 which are regularly disposed about the conduit section 40. Furthermore, the tapered sections 44 of the depicted stand 20 meet at corners which are, for the most part, rounded in shape as a path is traced from the regions where the straight-walled sections 42 are joined together downwardly to the conduit section 46.

It is a feature of the stand 20 that the discharge opening 38 is disposed to one side of the funnel portion 26 or, in other words, offset to one side of the vertical centerline, indicated 58 in FIGS. 4 and 5. Since replacement oil is commonly purchased in containers, like the container 30 of FIG. 6, whose mouth is disposed to one side of the vertical centerline of the container in an “easy to pour” configuration, the position of the discharge opening 38 relative to the vertical centerline 58 of the funnel portion 26 permits the container 30 to be positioned centrally of the support surface 34 of the base platform 22 while the mouth, indicated 48 in FIG. 6, of the container 30 is positionable in vertical registry with the discharge opening 38.

It is another feature of the stand 20 that it includes means, generally indicated 50, for supporting the funnel portion 26 in a spaced and elevated condition above the support surface 34 of the base platform 22. In this connection, the supporting means 50 includes the pair of legs 24, introduced earlier, which are disposed on opposite ends of the base platform 22 and extend upwardly therefrom to the funnel portion 26. Each leg 24 is relatively flat, or planar, in form and as seen in FIG. 4, has a shape which resembles an hourglass. In addition, the legs 24 are spaced a sufficient distance apart to accept a container 30 (FIG. 6) positioned upon the platform 22 and beneath the funnel portion 26. Moreover, each leg 24 is joined at its lower end to the base platform 22 at a corresponding end thereof and is joined at its upper end to a corresponding side of the funnel portion 26. If the stand 20 is molded as a unitary structure, the legs 24 can be formed integrally with the base platform 22 and funnel portion 26.

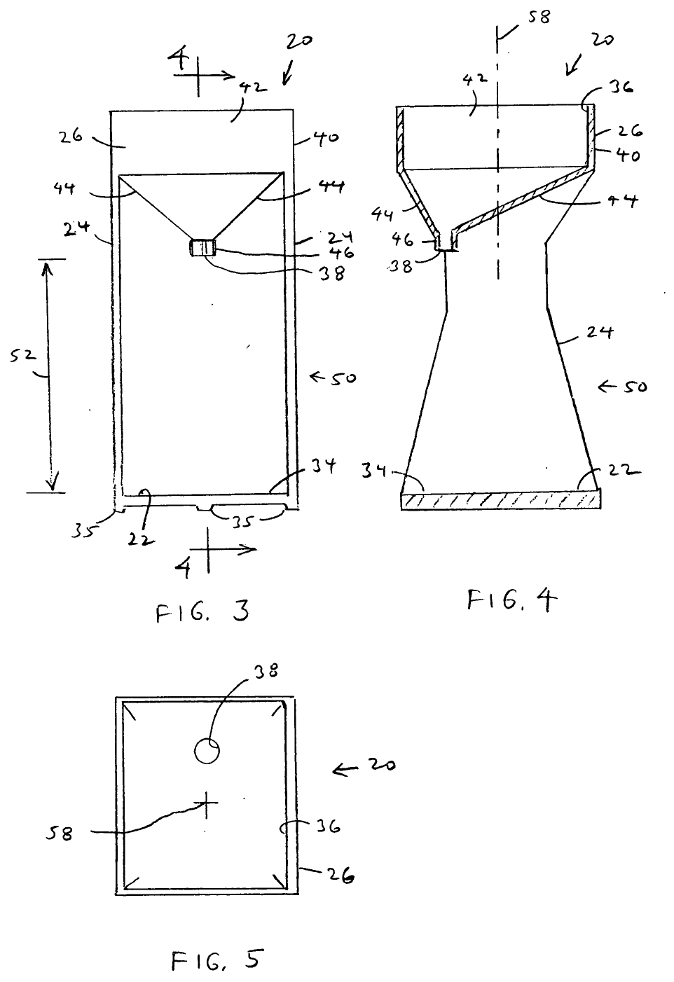

The legs 24 support the discharge opening 38 in a spaced relationship above the support surface 34 of the base platform 22 so that the height of the spacing, indicated 52 in FIG. 3, measured between the discharge opening 38 of the funnel portion 26 and the support surface 34 of the base platform 22 closely approximates the height of the small container 30 into which fluids are intended to be funneled with the stand 20. With the discharge opening 38 spaced above the support surface 34 in this manner, the container 30 (FIG. 6) can be positioned upon the support surface 34 and manipulated into place beneath the funnel portion 26 so that the (open) mouth of the container 30 is positioned in vertical registry with the discharge opening 38 of the funnel portion 26 and is closely positioned adjacent the discharge opening of the funnel portion to accept fluid which flows downwardly and out of the funnel portion 26 through the discharge opening 38 thereof. Furthermore, the container 30 is less likely to tip over when the open mouth of the container 30 is closely positioned adjacent the discharge opening 38 in this manner.

Desirably, the height of the spacing 52 as measured between the discharge opening 38 of the funnel portion 26 and the support surface 34 of the base platform 22 is within about 0.5 inches of the height of the container 30. To further reduce the likelihood that the container 30 will tip over as the container 30 is being filled beneath the funnel portion 26, it is preferable that the height of the spacing 52 as measured between the discharge opening 38 of the funnel portion and the support surface of the base platform 22 is slightly less than the height of the container 30 so that when the container 30 is positioned upon the support surface 34 of the base platform 22 so that the mouth of the container 30 is positioned in vertical registry with the discharge opening 34 of the funnel portion 26, the mouth of the container 30 encircles the discharge opening 38, or more specifically, the conduit section 46 of the funnel portion. With the container mouth encircling the discharge opening 34 in this manner, any tipping of the container 30 in one direction (e.g. rightwardly) or the other direction (e.g. leftwardly) will cause the inside surface of the container mouth to abut the outside surface of the conduit section 46 and thereby prevent the container 30 from tipping over any further.

The ribs 39 (FIG. 2a) defined along the conduit section 46 are advantageous when the mouth of the container 30 accepts, so as to encircle, the discharge opening 38. In particular, the ribs 39 permit the escape of air from the container 30 as the container 30 is being filled. In other words, as fluid is poured through the funnel portion 26 of the stand 20 and into the container 30, air is permitted to escape from the container interior through the spacings provided between the ribs 39 and the inside surface of the container mouth 48 (FIG. 6). This way, air which is present within the container 30 will not become trapped as fluid is poured therein so that the flow of additional fluid into the container 30 is not disrupted or prevented. By comparison, a funnel, like the funnel 18 of FIG. 1, which possesses a smooth outer surface and which rests upon a container so that the discharge opening of the funnel is disposed within the container mouth (having a smooth inner surface) is likely to cooperate with the container mouth to trap air within the container when fluid is poured into the container through such a smooth-surfaced funnel.

To position the container 30 within the stand 20 for use and with reference to FIG. 6, the container 30 (when empty) is positioned upon the base platform 22 so that the bottom of the container 30 rests upon the support surface 34 of the base platform 22 and so that the open mouth of the container is disposed in vertical registry with the downwardly-directed discharge opening 38 of the funnel portion 26 of the stand 20. Even if the height of the spacing as measured between the discharge opening 38 of the funnel portion 26 and the support surface of the base platform 22 is slightly less than the height of the container 30, the container 30 can be manipulated (e.g. moved in the direction of the arrow 66 from the position illustrated in phantom line in FIG. 6 to the position illustrated in solid lines in FIG. 6) so that the mouth of the container 30 encircles the discharge opening 38, or more specifically, the conduit section 46 of the funnel portion. With the container 30 positioned upon the base platform 22 in this manner, the fluid to be funneled into the container 30 is then poured into the funnel portion 26 of the stand 20 so that the fluid funnels downwardly into the empty container 30.

By monitoring the level of fluid collected within the container 30 as the container 30 is filled, the container will not be overfilled (in a manner causing the fluid to overflow the container mouth). Upon completion of the container-filling process, the container 30 is carefully removed from beneath the funnel portion 26 and closed, or capped, to prevent spillage of fluid from the container 30. If the container 30 has a cap which screws on or off the mouth to close or open the mouth, the cap is simply replaced upon the mouth to close the container 30. If additional fluid is to be collected (i.e. more than can be collected within one container 30), another container is positioned within the stand 20 so that its mouth is disposed in vertical registry with the discharge opening 38 of the funnel portion 26 and the container-filling process is repeated.

It follows from the foregoing that a funnel stand 20 has been described which facilitates the transfer of collected fluid (e.g. used motor oil) into a relatively small (e.g. quart-sized) container 30 while reducing the likelihood that the container 30 will tip over as the container is being filled. Furthermore, the funnel stand 20 is relatively compact in size, rendering it easy to store or transport, and uncomplicated in construction.

Exemplary dimensions of the stand 20 are as follows: The total height of the stand is about 12.375 inches; the (horizontally-measured) length and width of each of the base platform 22 and upper opening of the funnel portion 26 are about 6.0 inches and 5.5 inches, respectively; the discharge opening 38 is about 7.375 inches from the upper surface of the base platform 22; the (vertically-measured) length of the conduit section 46 is about 0.5 inches; and the outer diameter of the conduit section 46 is about 0.75 inches; the thickness of the base platform is about 0.5 inches; and the vertical centerline of the discharge opening 38 is offset from the vertical centerline 58 of the funnel portion 26 by about 1.5 inches.

It will be understood that numerous modifications and substitutions can be had to the aforedescribed embodiment 20 without departing from the spirit of the invention. For example, although the stand 20 of FIGS. 2-6 has been shown and described as including a funnel portion 26 possessing tapered sections 44 which meet at rounded corners, the funnel portion 26 may possess an alternative shape. For example and with reference to FIGS. 7 and 8, there is illustrated a funnel stand 60 which has a funnel portion 62 which includes tapered sidewall sections 68 which are joined to one another along linear corners 64. Accordingly, the aforedescribed embodiment 20 is intended for the purpose of illustration and not as limitation.

1. A funnel stand facilitating the funneling of fluid into a small container having an open mouth, the stand comprising:
a base platform having a support surface upon which a small, open-mouthed container is positionable so that the open mouth of the container is directed upwardly;
a funnel portion having a relatively large entrance opening and a smaller discharge opening; and
means for supporting the funnel portion in an elevated condition above the base platform for funneling a fluid poured into the funnel portion downwardly through the discharge opening thereof and so that the height of the spacing as measured between the discharge opening of the funnel portion and the support surface of the base platform closely approximates the height of the small container so that when the small container is positioned upon the support surface of the base platform so that the mouth of the small container is positioned in vertical registry with the discharge opening of the funnel portion, the mouth of the small container is closely positioned adjacent the discharge opening to accept fluid which flows out of the funnel portion through the discharge opening thereof.

2. The funnel stand as defined in claim 1 wherein the funnel portion-supporting means includes legs which are joined to and extend between the base platform and the funnel portion.

3. The funnel stand as defined in claim 1 wherein the funnel portion-supporting means includes two legs which are joined to and extend between the base platform and the funnel portion so that when the small container is positioned upon the support surface of the base platform, the small container is positioned between the two legs.

4. The funnel stand as defined in claim 1 wherein the base platform is relatively rectangular in shape with two opposite ends and the funnel portion-supporting means includes legs which are joined to and extend between the base platform and the funnel portion at the opposite ends of the base platform.

5. The funnel stand as defined in claim 1 wherein the height of the spacing as measured between the discharge opening of the funnel portion and the support surface of the base platform is slightly less than the height of the small container so that when the small container is positioned upon the support surface of the base platform so that the mouth of the small container is positioned in vertical registry with the discharge opening of the funnel portion, the mouth of the small container encircles the discharge opening of the funnel portion.

6. The funnel stand as defined in claim 5 wherein the discharge opening of the funnel portion is provided by a cylindrically-shaped conduit section, and the conduit section has an outer surface which defines a plurality of outwardly-projecting ribs for ensuring that air is permitted to escape from the mouth of a small container when the mouth of the small container is positioned in vertical registry with the discharge opening of the funnel portion and fluid is funneled into the mouth of the container.

7. The funnel stand as defined in claim 1 wherein the height of the spacing as measured between the discharge opening of the funnel portion and the support surface of the base platform is within about 0.5 inches of the height of the small container.

8. The funnel stand as defined in claim 1 wherein the stand is constructed of plastic.

9. The funnel stand as defined in claim 1 wherein the funnel portion has a vertical centerline and the discharge opening of the funnel portion is offset to one side of the vertical centerline of the funnel portion.

10. A funnel stand for use when funneling fluid into a quart-sized container having an open mouth, the stand comprising:
a funnel portion having a downwardly-directed discharge opening;
a base platform having a support surface upon which a quart-sized container is positionable so that the open mouth of the container is directed upwardly; and
means for supporting the funnel portion in a spaced and elevated condition above the base platform so that when a quart-sized container is positioned upon the base platform, the open mouth of the container is positionable in vertical registry with and in close proximity to the discharge opening of the funnel portion.

11. The funnel stand as defined in claim 10 wherein the funnel portion-supporting means includes legs which are joined to and extend between the base platform and the funnel portion.

12. The funnel stand as defined in claim 10 wherein the funnel portion-supporting means includes two legs which are joined to and extend between the base platform and the funnel portion so that when the quart-sized container is positioned upon the support surface of the base platform, the quart-sized container is positioned between the two legs.

13. The funnel stand as defined in claim 10 wherein the height of the spacing as measured between the discharge opening of the funnel portion and the support surface of the base platform is slightly less than the height of the quart-sized container so that when the quart-sized container is positioned upon the support surface of the base platform so that the mouth of the quart-sized container is positioned in vertical registry with the discharge opening of the funnel portion, the mouth of the quart-sized container encircles the discharge opening of the funnel portion.

14. The funnel stand as defined in claim 10 wherein the height of the spacing as measured between the discharge opening of the funnel portion and the support surface of the base platform is within about 0.5 inches of the height of the quart-sized container.

15. The funnel stand as defined in claim 10 wherein the stand is constructed of plastic.

16. The funnel stand as defined in claim 10 wherein the funnel portion has a vertical centerline and the discharge opening of the funnel portion is offset to one side of the vertical centerline of the funnel portion to facilitate the positioning of the mouth of the quart-sized container in vertical registry with the discharge opening of the funnel portion when the open mouth of the quart-sized container is offset to one side thereof.

17. In combination, a quart-sized container having a vertical centerline and an upwardly-directed open mouth which is offset to one side of the vertical centerline, and
a funnel stand facilitating the funneling of fluid into the quart-sized container, wherein the funnel stand includes:
a) a base platform having a support surface upon which the open-mouthed quart-sized container is positionable so that the open mouth of the container is directed upwardly;
b) a funnel portion having a relatively large entrance opening and a smaller discharge opening; and
c) means for supporting the funnel portion in a spaced and elevated condition above the base platform for funneling a fluid poured into the funnel portion downwardly through the discharge opening thereof and so that the height of the spacing as measured between the discharge opening of the funnel portion and the support surface of the base platform closely approximates the height of the quart-sized container so that when the quart-sized container is positioned upon the support surface of the base platform and the mouth of the quart-sized container is positioned in vertical registry with the discharge opening of the funnel portion, the mouth of the quart-sized container is closely positioned adjacent the discharge opening of the funnel portion to accept fluid which is discharged from the funnel portion by way of the discharge opening.

18. The combination as defined in claim 17 wherein the height of the spacing as measured between the discharge opening of the funnel portion and the support surface of the base platform is within about 0.5 inches of the height of the quart-sized container.

19. The combination as defined in claim 17 wherein the height of the spacing as measured between the discharge opening of the funnel portion and the support surface of the base platform is slightly less than the height of the quart-sized container so that when the quart-sized container is positioned upon the support surface of the base platform so that the mouth of the quart-sized container is positioned in vertical registry with the discharge opening of the funnel portion, the mouth of the quart-sized container encircles the discharge opening of the funnel portion.

20. The combination as defined in claim 17 wherein the funnel portion has a vertical centerline and the discharge opening of the funnel portion is offset to one side of the vertical centerline of the funnel portion to facilitate the positioning of the quart-sized container in vertical registry with the discharge opening of the funnel portion when the quart-sized container is positioned upon the support surface of the base platform.
